(19) United States
(12) Patent Application Publication
(10) Pub. No.: US 2012/0051302 A1
(43) Pub. Date: Mar. 1, 2012

(54) ANTENNA DEVICE, COMMUNICATION SYSTEM, BASE STATION DEVICE, AND COMMUNICATION METHOD

(75) Inventor: Hiroyuki SEKI, Kawasaki (JP)

(73) Assignee: FUJITSU LIMITED, Kawasaki-shi (JP)

(21) Appl. No.: 13/213,323

(22) Filed: Aug. 19, 2011

(30) Foreign Application Priority Data
Aug. 26, 2010 (JP) 2010-189347

(51) Int. Cl. H04W 72/00

(52) U.S. Cl. 370/329

(57) ABSTRACT

An antenna device connected to a base station device via a cascade connection, includes a first receiver that receives, from the base station device, subband information specifying a subband that is among a plurality of subbands obtained by dividing a frequency band and is not assigned to a mobile station device, a second receiver that receives, from another antenna device connected on a downstream side of the cascade connection, an upstream link signal transmitted by the mobile station device and received by the other antenna device and reception quality information of the upstream link signal, a wireless receiver that receives a wireless upstream link signal transmitted by the mobile station device, and a comparator that compares quality of the wireless upstream link signal with the reception quality information based on power of the wireless upstream link signal and power of a received signal in the subband.

### CROSS-REFERENCE TO RELATED APPLICATION

This application is based upon and claims the benefit of priority of prior Japanese Patent Application No. 2010-189347, filed on Aug. 26, 2010, the entire contents of which are incorporated herein by reference.

### FIELD

The embodiments discussed in the present application relate to a communication system having a plurality of antenna devices connected to a base station device in cascade, an antenna device included in the communication system, the base station device included in the communication system, and a communication method.

### BACKGROUND

An antenna system has been proposed, which transmits and receives a signal between a base station device and a mobile station device using a plurality of antenna devices that are distributed and connected in cascade to the base station device through lines.

When the base station device transmits a downstream link signal toward the mobile station device, the antenna devices each receive the downstream link signal from the base station device located on the upstream side of the antenna device or from another antenna device located on the upstream side of the antenna device. The antenna devices each transmit the received downstream link signal to the mobile station device through a wireless connection, copy the downstream link signal, and transfer the downstream link signal to another antenna device located on the downstream side of the antenna device.

When the mobile station device transmits an upstream link signal toward the base station device, the antenna devices each receive the upstream link signal from the mobile station device through the wireless connection. A frequency band for an upstream link is divided into a plurality of subbands. The subbands are assigned to users or the mobile station devices. The antenna devices each combine the signal received from the mobile station device through the wireless connection with the upstream link signal received from the other downstream-side antenna device. The antenna devices each transfer the combined upstream link signal to the base station device located on the upstream side of the antenna device or another antenna device located on the upstream side of the antenna device.

### SUMMARY

According to an aspect of the embodiments discussed herein, an antenna device is provided that is connected to a base station device via a cascade connection. The antenna device includes a first receiver that receives, from the base station device, subband information that specifies a subband that is among a plurality of subbands obtained by dividing a frequency band and is not assigned to a mobile station device, a second receiver that receives, from another antenna device connected on a downstream side of the cascade connection, an upstream link signal transmitted by the mobile station device and received by the other antenna device and reception quality information of the upstream link signal, a wireless receiver that receives a wireless upstream link signal transmitted by the mobile station device, and a comparator that compares quality of the wireless upstream link signal with the reception quality information based on power of the wireless upstream link signal and power of a received signal in the subband specified in the subband information.

Additional objects and advantages of the embodiments will be set forth in part in the description which follows, and in part will be obvious from the description, or may be learned by practice of the embodiments. The object and advantages of the embodiments will be realized and attained by means of the elements and combinations particularly pointed out in the appended claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating a configuration of a communication system.

FIG. 2 is a diagram illustrating a first example of a configuration of a base station device.

FIG. 3 is a diagram illustrating an example of a signal format to be transmitted through a digital signal line.

FIG. 4 is a diagram illustrating an example of an antenna device.

FIG. 5 is a diagram illustrating a first example of a signal processing unit.

FIG. 6 is a flowchart of a first example of a process to be performed by the antenna device.

FIG. 7 is a flowchart of a first example of a first process of determining a signal to be transmitted.

FIG. 8 is a flowchart of a second example of the first process of determining a signal to be transmitted.

FIG. 9 is a diagram illustrating a second example of the signal processing unit.

FIG. 10 is a flowchart of a second example of the process to be performed by the antenna device.

FIG. 11 is a flowchart of an example of a second process of determining a signal to be transmitted.

FIG. 12 is a diagram illustrating requirements to select a signal to be stored in a storage region provided for an unassigned subband and included in the signal format and to be transmitted.

FIG. 13 is a diagram illustrating a second example of the configuration of the base station device.

### DESCRIPTION OF EMBODIMENTS

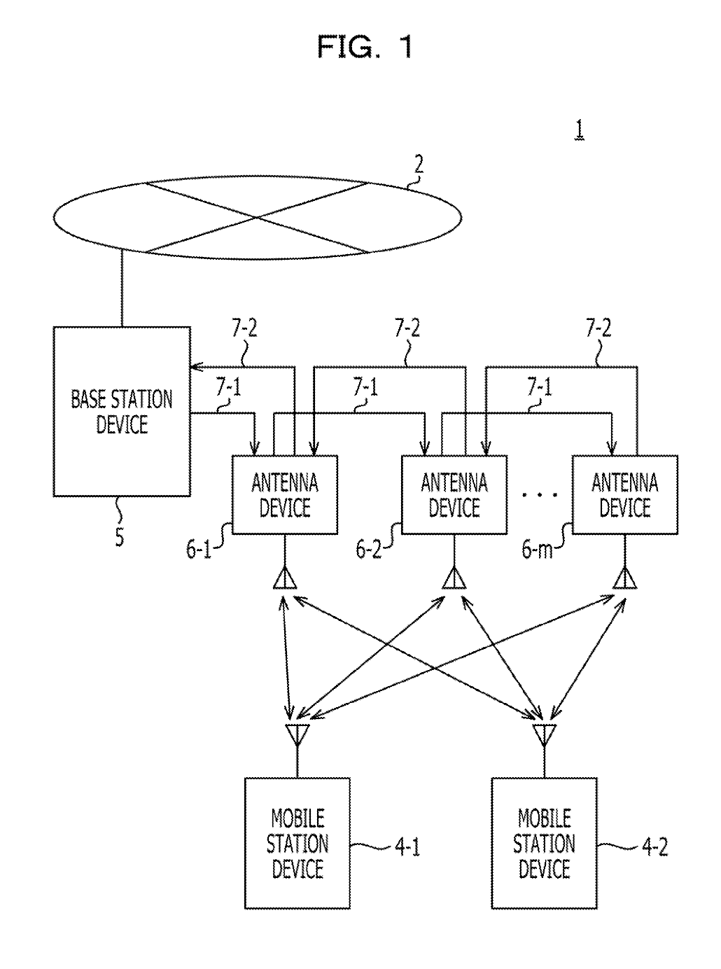

The embodiments disclosed herein are described with reference to the accompanying drawings. FIG. 1 is a diagram illustrating a configuration of a communication system. A communication system 1 includes a core network 2, a plurality of mobile station devices 4-1 and 4-2, a base station device 5 and a plurality of antenna devices 6-1 to 6-m. The mobile station devices 4-1 and 4-2 are hereinafter collectively called “mobile station devices 4” in some cases. The antenna devices 6-1 to 6-m are hereinafter collectively called “antenna devices 6” in some cases.

The plurality of antenna devices 6-1 to 6-m are connected in cascade to each other through digital signal lines 7-1 and 7-2. Each of the digital signal lines 7-1 and 7-2 has a given band width. The digital signal lines 7-1 are used for transmission of a downstream link signal from the base station device 5 to the mobile station devices 4. In addition, the digital signal lines 7-1 are used for transmission of a given control signal from the base station device 5 to the antenna devices 6. The signals pass through the digital signal lines 7-1 from the upstream side to the downstream side between the antenna devices 6-1 and 6-m connected to each other in cascade.

The digital signal lines 7-2 are used for transmission of an upstream link signal from the mobile station devices 4 to the base station device 5. In addition, since the digital signal lines 7-2 are used for transmission of a given control signal from the antenna devices 6 to the base station device 5, the digital signal lines 7-2 are used for transmission of a given control signal from a downstream-side antenna device among the antenna devices 6 to an upstream-side antenna device among the antenna devices 6. The signals pass through the digital signal lines 7-2 from the downstream side to the upstream side between the antenna devices 6-m and 6-1 connected to each other in cascade. The digital signal lines 7-1 and 7-2 are hereinafter collectively called the “digital signal lines 7” in some cases.

For the antenna system, desired signals that are included in signals received in a certain subband by a number m of antenna devices 6-1 to 6-m are indicated by S1 to Sm; inter-cell interference components that are included in the signals received in the certain subband by the number m of the antenna devices 6-1 to 6-m are indicated by I1 to Im; and thermal noise components that are included in the signals received in the certain subband by the number m of the antenna devices 6-1 to 6-m are indicated by N1 to Nm. A signal to interference plus noise ratio (SINR) that indicates the quality of a signal formed by combining the received signals is expressed by the following Equation (1). In the following description, an inter-cell interference component and a thermal noise component are collectively called an “undesired signal” in some cases.

SINR=(S1+ . . . +Sm)/(I1+ . . . +Im+N1+ . . . +Nm) (1)

Referring to Equation (1), even when the signals that are received by the number m of the antenna devices 6-1 to 6-m are combined, the undesired signals that are received by the antenna devices are added to the combined signal. Thus, it may not be expected to improve the qualities of the received signals. Specifically, when a received signal with a low quality is combined with a certain signal, the quality of the certain signal may be lowered.

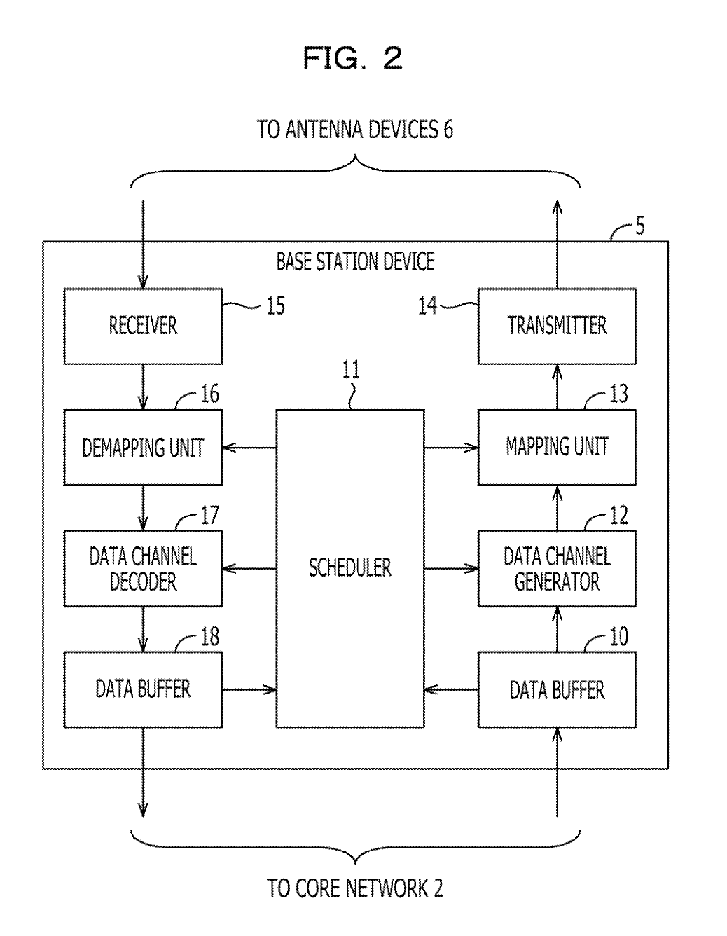

Next, a configuration of the base station device 5 is described. FIG. 2 is a diagram illustrating a first example of the configuration of the base station device 5. The base station device 5 includes data buffers 10, 18, a scheduler 11, a data channel generator 12, a mapping unit 13 and a transmitter 14. In addition, the base station device 5 includes a receiver 15, a demapping unit 16 and a data channel decoder 17.

The scheduler 11 is an example of an assigning unit. In addition, the transmitter 14 is an example of a subband information transmitter.

When the base station device 5 receives data of a downstream link signal (to be transferred to the mobile station devices 4) from the core network 2, the base station device 5 stores the received data in the data buffer 10. The scheduler 11 divides a frequency band specified for transmission of the downstream link signal and a frequency band specified for transmission of the upstream link signal into a plurality of subbands. The scheduler 11 determines, based on the amount of the data stored in the data buffer 10, subbands to be assigned to users or the mobile station devices 4.

The data channel generator 12 performs error coding and modulation on the data (of the downstream link signal) stored in the data buffer 10 based on assignment information that indicates the assignments of the subbands determined by the scheduler 11. The mapping unit 13 maps the coded data of the downstream link signal in a signal format of a given digital signal based on the assignment information.

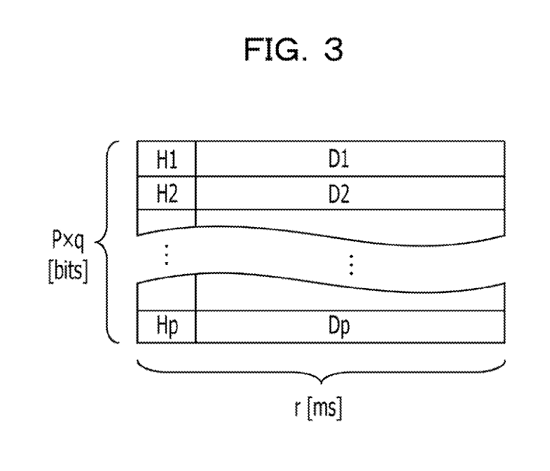

FIG. 3 is a diagram illustrating an example of the signal format that is transmitted through the digital signal lines 7. In the following description, it is assumed that the number of the subbands is p. The signal format has data portions D1 to Dp and header portions H1 to Hp for the subbands #1 to #p. Data of upstream link signals that are to be transmitted in the subbands #1 to #p are stored in the data portions D1 to Dp. Given control signals such as information on use of the subbands #1 to #p are stored in the header H1 to Hp. The signal format has a bit width of q bits for each of the subbands. A time period in which each of the subbands is occupied per transmission is r milliseconds.

Refer to FIG. 2. The scheduler 11 generates subband information that specifies a subband that is not assigned to the mobile station devices 4 and is provided for an upstream link. The mapping unit 13 multiplexes the subband information into the data of downstream link signals. In the following description, the subband that is specified in the subband information is called the “unassigned subband” in some cases.

The mapping unit 13 may multiplex the subband information into the data of the downstream link signals by causing information indicating whether or not the subbands for upstream links are assigned to be stored in the header portions H1 to Hp of the signal format illustrated in FIG. 3, for example. In addition, the mapping unit 13 may multiplex the subband information into a signal to be transmitted through the digital signal lines 7-1, instead of the signal format illustrated in FIG. 3. The transmitter 14 may multiplex the subband information into the data of the downstream link signals or the signal to be transmitted through the digital signal lines 7-1.

The transmitter 14 transmits the signal format having the downstream link signals mapped therein to the antenna devices 6 through the digital signal lines 7-1.

The receiver 15 receives, from the antenna device 6 through the digital signal line 7-2, a signal format that has upstream link signals stored therein. In this case, the signal format may be the same as the signal format illustrated in FIG. 3. The demapping unit 16 separates data of the upstream link signals received in the subbands from the signal format for the users.

For example, user numbers of the users to which the subbands are assigned may be stored in the header portions H1 to Hp of the signal format illustrated in FIG. 3. In this case, the demapping unit 16 references the user numbers stored in the header portions H1 to Hp and separates the data stored in the signal format from the signal format for the users.

The data channel decoder 17 demodulates and decodes the data separated for the users. The decoded data of the upstream link signals is stored in the data buffer 18 until the data is transmitted to the core network 2.

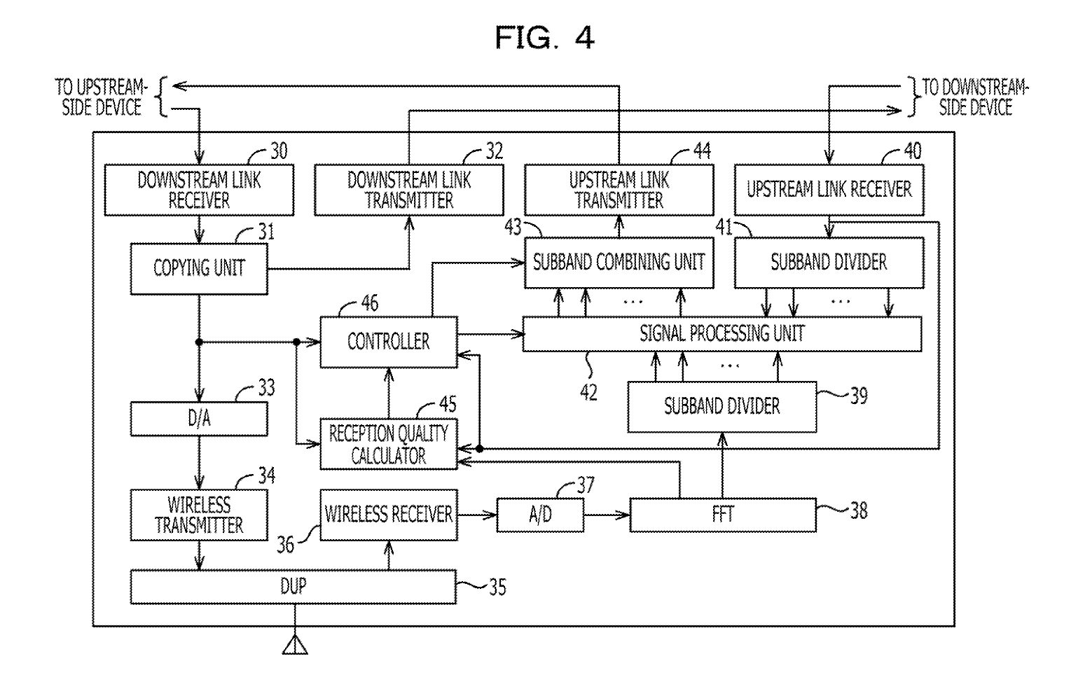

Next, the configuration of each of the antenna devices 6 is described. FIG. 4 is a diagram illustrating an example of the configuration of each of the antenna devices 6. The antenna devices 6 each include a downstream link receiver 30, a copying unit 31, a downstream link transmitter 32, a digital analog converter 33, a wireless transmitter 34, and a duplexer 35. In addition, the antenna devices 6 each further include a wireless receiver 36, an analog digital converter 37, a Fourier transformer 38, subband dividers 39, 41 and an upstream link receiver 40.

In addition, the antenna devices 6 each further include a signal processing unit 42, a subband combining unit 43, an upstream link transmitter 44, a reception quality calculator 45 and a controller 46. In FIG. 4, the digital analog converter is indicated by “D/A”; the duplexer is indicated by “DUP”; the analog digital converter is indicated by “A/D”; and the Fourier transformer is indicated by “FFT”.

The downstream link receiver 30 is an example of a first receiver. The upstream link receiver 40 is an example of a second receiver. The Fourier transformer 38 and the reception quality calculator 45 are an example of a reception power measuring unit.

The reception quality calculator 45 is an example of a reception quality calculator. The controller 46 is an example of a comparator and an example of a determining unit. The upstream link transmitter 44 is an example of a transmitter of an antenna device. The subband combining unit 43 is an example of a signal generator.

The downstream link receiver 30 receives the signal format having the downstream link signals mapped therein through the digital signal line 7-1 from the base station device 5 connected through the digital signal lines 7 to the interested antenna device 6 on the upstream side of the interested antenna device 6 or from another antenna device connected through the digital signal lines 7 to the interested antenna device 6 on the upstream side of the interested antenna device 6. In the following description, the base station device that is connected through the digital signal lines 7 to the interested antenna device 6, or the other antenna device that is connected through the digital signal lines 7 to the interested antenna device 6, is called an “upstream-side device” in some cases. In the following description, another antenna device that is among the antenna devices and connected to the interested antenna device 6 through the digital signal lines 7 is called a “downstream-side device” in some cases. The downstream link receiver 30 receives the subband information from the upstream-side device through the digital signal line 7-1.

The copying unit 31 copies the signal received by the downstream link receiver 30 and causes the same signal as the signal received by the downstream link receiver 30 to be input to the downstream link transmitter 32. The downstream link transmitter 32 transmits the copied signal to the downstream-side device.

The digital analog converter 33 converts the signal received by the downstream link receiver 30 into an analog signal. The wireless transmitter 34 converts the analog signal converted by the digital analog converter 33 into a wireless frequency signal. The wireless transmitter 34 outputs the wireless frequency signal through the duplexer 35 to an antenna included in the antenna device 6. Then, the wireless frequency signal is transmitted from the antenna included in the antenna device 6.

Wireless upstream link signals that are transmitted from the mobile station devices 4 are received by the antenna included in the antenna device 6. The wireless signals received by the antenna are input to the wireless receiver 36 through the duplexer 35. The wireless receiver 36 converts the received wireless frequency signals into baseband signals. The analog digital converter 37 converts the baseband signals output from the wireless receiver 36 into digital signals. In the following description, the upstream link signals that are received from the mobile station devices 4 through wireless connections are called the “wireless connection upstream link signals” in some cases.

The Fourier transformer 38 converts the received converted digital signals into frequency domain signals by performing Fourier transform. The frequency domain signals are each output from the Fourier transformer 38 and input to the reception quality calculator 45 and the subband divider 39.

The subband divider 39 divides each of the frequency domain signals received from the Fourier transformer 38 into frequency domain signals (of the wireless connection upstream link signal) for the subbands #1 to #p. The subband divider 39 causes the frequency domain signals (of the wireless connection upstream link signal) for the subbands #1 to #p to be input to the signal processing unit 42.

An upstream link signal that is received by the downstream-side device from the mobile station device 4 is transmitted from the downstream-side device through the digital signal line 7-2 to the antenna device 6. The upstream link receiver 40 receives the upstream link signal (received by the downstream-side device) from the downstream-side device through the digital signal line 7-2. In the following description, the upstream link signal that is received from the downstream-side device through the digital signal line 7-2 is called the “wired line upstream link signal” in some cases.

The wired line upstream link signal may be divided into signals for the subbands and stored in the signal format illustrated in FIG. 3. In this case, the upstream link signals are stored in the data portions D1 to Dp in the form of a frequency band signal.

In addition, the upstream link receiver 40 receives reception quality information from the downstream-side device through the digital signal line 7-2. The reception quality information indicates the quality of each of wired line upstream link signals received in the subbands #1 to #p. The reception quality information includes at least two of a signal to interference plus noise ratio, the intensity of a desired signal, and the intensity of an undesired signal.

The reception quality information may be stored in the header portions H1 to Hp and transmitted through the digital signal line 7-2. The reception quality information may be transmitted separately from the signal format illustrated in FIG. 3. The upstream link receiver 40 outputs the received reception quality information to the reception quality calculator 45. The upstream link receiver 40 may output the received reception quality information to the controller 46.

The subband divider 41 divides the wired link upstream link signal into frequency domain signals (of the upstream link signal) for the subbands #1 to #p. The subband divider 41 causes the frequency domain signals (of the upstream link signal) for the subbands #1 to #p to be input to the signal processing unit 42.

The signal processing unit 42 selects a signal for each of the subbands #1 to #p from among the upstream link signals received from the subband divider 41, the upstream link signals received from the subband divider 39 and signals formed by combining the upstream link signals received from the subband divider 41 with the upstream link signals received from the subband divider 39. The signal processing unit 42 outputs the selected signals to the subband combining unit 43. In the aforementioned case, the signal processing unit 42 selects the signals in accordance with an instruction provided from the controller 46.

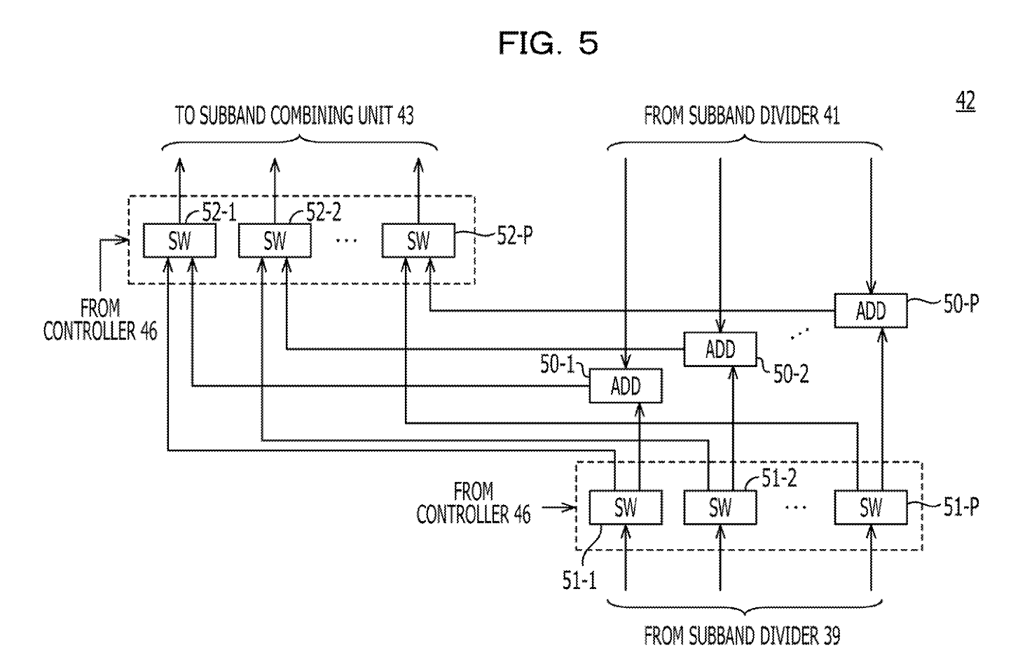

FIG. 5 is a diagram illustrating a first example of the signal processing unit 42. The signal processing unit 42 includes a number p of combining units 50-1 to 50-p, and a number (2×p) of switches 51-1 to 51-p and 52-1 to 52-p. In FIG. 5, the combining units are each indicated by “ADD”, and the switches are each indicated by “SW”. In the following description, the combining units 50-1 to 50-p are collectively called the “combining units 50” in some cases. In the following description, the switches 51-1 to 51-p are collectively called the “switches 51” in some cases; and the switches 52-1 to 52-p are collectively called the “switches 52” in some cases.

In addition, the combining units 50 are an example of a combining unit of the antenna device. The switches 51 and 52 are an example of a first selector.

The switches 51-1 to 51-p each have an input, a first output and a second output. The combining units 50-1 to 50-p each have a first input, a second input and an output. The switches 52-1 to 52-p each have a first input, a second input and an output.

The switches 51-1 to 51-p each switch the output for a signal received by the input between the first and second outputs in accordance with an instruction signal received from the controller 46. The inputs of the switches 51-1 to 51p are connected to outputs of the subband divider 39. The frequency domain signals (of the wireless connection upstream link signal) that are output in the subbands #1 to #p from the subband divider 39 are input to the switches 51-1 to 51-p.

The first outputs of the switches 51-1 to 51-p are connected to the first inputs of the combining units 50-1 to 50-p. The second outputs of the switches 51-1 to 51-p are connected to the first inputs of the switches 52-1 to 52-p.

The second inputs of the combining units 50-1 to 50-p are connected to outputs of the subband dividers 41. The frequency domain signals (of the wired line upstream link signal) that are output in the subbands #1 to #p from the subband divider 41 are input to the combining units 50-1 to 50-p. The combining units 50-1 to 50-p each combine the frequency domain signals (of the upstream signals) received in the subbands #1 to #p through the first and second inputs of the combining unit and output the combined signal. The outputs of the combining units 50-1 to 50-p are connected to the second inputs of the switches 52-1 to 52-p.

The switches 52-1 to 52-p each select either the signal received by the first input or the signal received by the second input in accordance with an instruction signal received from the controller 46. The outputs of the switches 52-1 to 52-p are connected to the subband combining unit 43.

When the wireless connection upstream link signal is received by the signal processing unit 42 from the subband divider 39 and is to be output from the signal processing unit 42, the controller 46 sets outputs for the received signal to the second outputs of the switches 51. In addition, the controller 46 sets inputs for the signals (to be output) to the first inputs of the switches 52.

When the wired line upstream link signal is received by the signal processing unit 42 from the subband divider 41 and is to be output from the signal processing unit 42, the controller 46 sets outputs for the received signal to the second outputs of the switches 51. In addition, the controller 46 sets inputs for the signals (to be output) to the second inputs of the switches 52.

When the signal that is formed by combining the upstream link signals received from the subband dividers 39 and 41 is to be output from the signal processing unit 42, the controller 46 sets outputs for the received signal to the first outputs of the switches 51. In addition, the controller 46 sets inputs for the signal (to be output) to the second inputs of the switches 52.

Referring to FIG. 4, the subband combining unit 43 generates a digital signal (to be transmitted through the digital signal line 7-2) by storing, in the signal format illustrated in FIG. 3, the frequency domain signals (of the upstream signal) output in the subbands #1 to #p from the signal processing unit 42. The upstream link transmitter 44 transmits the digital signal generated by the subband combining unit 43 to the upstream-side device.

The reception quality calculator 45 calculates the intensities (power) of the signals received in the subbands based on the frequency domain signals formed by converting the received signals and output from the Fourier transformer 38 and thereby calculates the qualities of the signals received in the subbands. The reception quality calculator 45 specifies the unassigned subband based on the subband information received by the downstream link receiver 30. The reception quality calculator 45 treats the intensity (power) r2 of a signal received in the unassigned subband as the intensity of an undesired signal.

When the intensity (power) of a signal received in a desired subband is indicated by r1, the reception quality calculator 45 calculates the quality Q2 of the wireless upstream link signal received in the desired subband according to the following Equation (2).

Q2=(r1−r2)/r2 (2)

The reception quality calculator 45 outputs the calculated quality Q2 to the controller 46. When the reception quality information that indicates the quality of the received wired line upstream link signal is indicated by the intensity of the desired signal and the intensity of the undesired signal, the reception quality calculator 45 may calculate the quality Q1 of the wired line upstream link signal according to the following Equation (3).

Q1=(The intensity of the desired signal)/(The intensity of the undesired signal) (3)

The reception quality calculator 45 may output the calculated quality Q1 to the controller 46. When the reception quality information that indicates the quality of the received wired line upstream link signal is indicated by the signal to interference plus noise ratio, the controller 46 uses the received signal to interference plus noise ratio as the quality Q1 of the wireless line upstream link signal.

The controller 46 determines, for each of the subbands, whether or not the quality Q1 of the received wired line upstream link signal and the quality Q2 of the received wireless connection upstream link signal satisfy a given requirement. The given requirement may be a requirement to determine the magnitude relationship between the qualities Q1 and Q2. For example, when the difference between the quality Q1 and the quality Q2 is equal to or smaller than a given threshold, or when the ratio of the qualities Q1 and Q2 is equal to or smaller than a given threshold, the controller 46 may determine that the qualities Q1 and Q2 satisfy the given requirement.

When the qualities Q1 and Q2 of signals received in a certain subband satisfy the given requirement, the controller 46 outputs an instruction signal to the signal processing unit 42 to instruct the signal processing unit 42 to output a signal formed by combining the upstream link signals (received from the subband divider 39 and 41) in the certain band.

As a result, the signal that is formed by combining the wireless connection upstream link signal with the wired line upstream link signal is output by the upstream link transmitter 44 for the certain subband. In this case, the controller 46 calculates the quality of the received combined signal and generates reception quality information that indicates the quality of the received combined signal.

The intensity of the desired signal received by the wireless receiver 36 is indicated by s2; the intensity of the undesired signal received by the wireless receiver 36 is indicated by n2; the intensity of the desired signal that is indicated in the reception quality information of the upstream link signal received from the downstream-side device is indicated by s1; and the intensity of the undesired signal that is indicated in the reception quality information of the upstream link signal received from the downstream-side device is indicated by n1. In this case, the controller 46 may calculate the quality Q3 of the combined signal according to the following Equation (4).

Q3=(s1+s2)/(n1+n2) (4)

When the qualities Q1 and Q2 of the signals received in the certain subband do not satisfy the given requirement, the controller 46 determines whether the quality Q1 or Q2 is higher than the other. When the quality Q1 is higher than the quality Q2, the controller 46 outputs an instruction signal to the signal processing unit 42 to instruct the signal processing unit 42 to output the upstream link signal received from the subband divider 41 for the certain subband. As a result, the wired line upstream link signal in the certain subband is output by the upstream link transmitter 44. In this case, the controller 46 generates reception quality information that indicates the quality Q1.

When the quality Q2 is higher than the quality Q1, the controller 46 outputs an instruction signal to the signal processing unit 42 to instruct the signal processing unit 42 to output the upstream link signal received from the subband divider 39 for the certain subband. As a result, the wireless connection upstream link signal in the certain subband is output by the upstream link transmitter 44. In this case, the controller 46 generates reception quality information that indicates the quality Q2.

The controller 46 outputs the reception quality information to the subband combining unit 43. The subband combining unit 43 causes the reception quality information to be stored in the header portions H1 to Hp of the signal format illustrated in FIG. 3. As a result, the antenna device 6 transmits the reception quality information of the upstream link signal to the upstream-side device through the digital signal line 7-2. In addition, the controller 46 may control the upstream link transmitter 44 so that the upstream link transmitter 44 transmits the reception quality information of the upstream link signal to the upstream-side device separately from the signal format illustrated in FIG. 3.

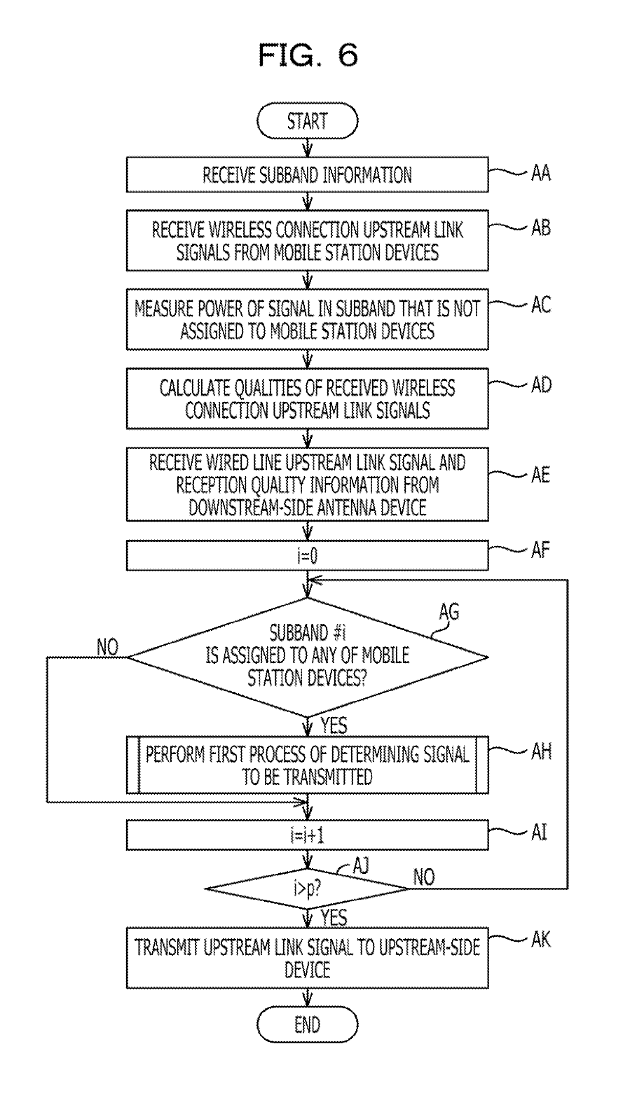

Next, a process that is performed by each of the antenna devices 6 is described. FIG. 6 is a flowchart of a first example of the process to be performed by the antenna device 6. In another embodiment, operations AA to AK that are described below may be steps.

In the operation AA, the downstream link receiver 30 receives the subband information transmitted by the base station device 5 through the digital signal line 7-1. The downstream link receiver 30 outputs the subband information to the controller 46. The downstream link receiver 30 may output the subband information to the reception quality calculator 45.

In the operation AB, the wireless receiver 36 receives the wireless upstream link signals transmitted by the mobile station devices 4. The received upstream link signals are converted into frequency domain signals by the Fourier transformer 38. The frequency domain signals are input to the subband divider 39 and the reception quality calculator 45. The operation AA may be performed before the operation AB, or the operation AB may be performed before the operation AA.

The subband divider 39 divides each of the frequency domain signals into signals for the subbands, and outputs the divided frequency domain signals for the subbands to the signal processing unit 42.

In the operation AC, the reception quality calculator 45 calculates, as the intensity r2 of the undesired signal, the intensity (power) of a signal that has been received in the unassigned subband and is among the frequency domain signals received from the Fourier transformer 38.

In the operation AD, the reception quality calculator 45 calculates the intensities (power) r1 of signals in the subbands. The reception quality calculator 45 calculates the qualities Q2 of wireless connection upstream link signals in the subbands according to the aforementioned Equation (2).

In the operation AE, the upstream link receiver 40 receives the wired line upstream link signal. In addition, the upstream link receiver 40 receives, through the digital signal line 7-2, the reception quality information that indicates the quality of the received wired line link signal. The quality that is indicated in the reception quality information is indicated by Q1 and representative of the qualities of signals received in the subbands. The operation AE may be performed before the operations AA to AD. Alternatively, the operations AA to AD may be performed before the operation AE.

The upstream link receiver 40 outputs the wired line upstream link signal to the subband divider 41. The subband divider 41 divides the wired line upstream link signal into frequency domain signals for the subbands. The subband divider 41 outputs the frequency domain signals in the subbands to the signal processing unit 42.

In the following operations AF to AJ, a process is repeatedly performed for the number p of the subbands. An index variable “i” that specifies a subband #i (i=1 to p) is used. In the operation AF, the controller 46 substitutes 1 into the index variable i.

In the operation AG, the controller 46 determines whether or not the subband #i is assigned to any of the mobile station devices 4. When the subband #i is assigned to any of the mobile station devices 4 (Yes in the operation AG), the process proceeds to the operation AH. When the subband #i is not assigned to any of the mobile station devices 4 (No in the operation AG), the process proceeds to the operation AI.

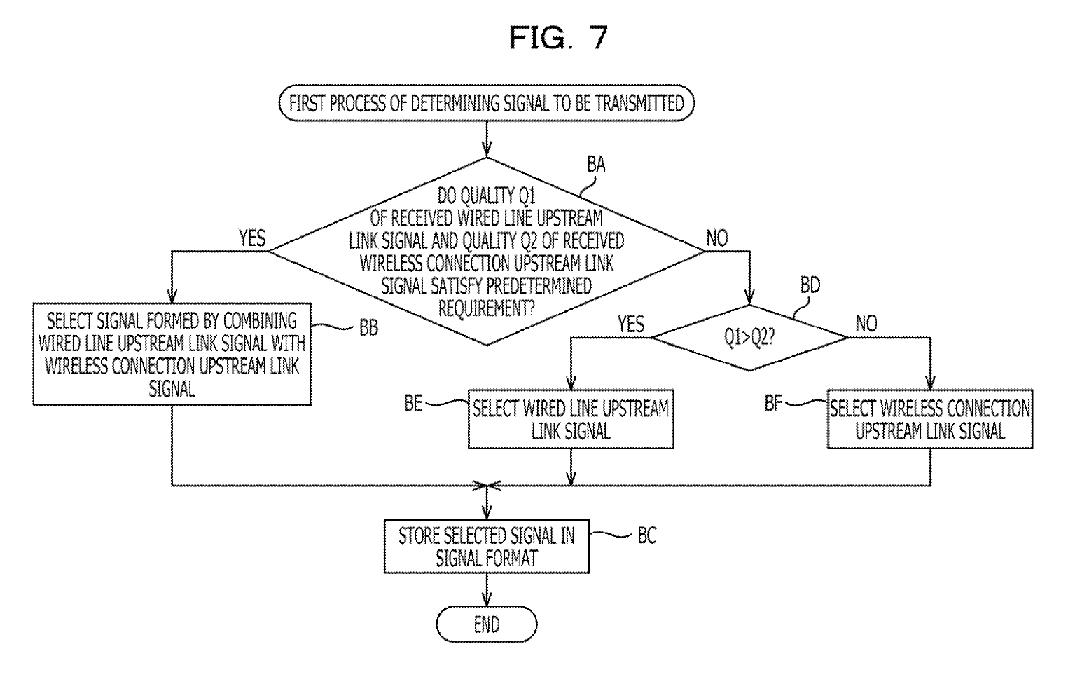

In the operation AH, the controller 46 performs a first process of determining an upstream link signal to be transmitted to the upstream-side device through the digital signal line 7-2. FIG. 7 is a flowchart of a first example of the first process of determining an upstream link signal to be transmitted. In another embodiment, the following operations BA to BF may be steps.

In the operation BA, the controller 46 determines whether or not the quality Q1 of a wired line upstream link signal received in the subband #i and the quality Q2 of a wireless connection upstream link signal received in the subband #i satisfy the given requirement. When the qualities Q1 and Q2 satisfy the given requirement (Yes in the operation BA), the process proceeds to the operation BB. When the qualities Q1 and Q2 do not satisfy the given requirement (No in the operation BA), the process proceeds to the operation BD.

In the operation BB, the controller 46 outputs an instruction signal to the signal processing unit 42 to instruct the signal processing unit 42 to select, as a signal to be output, a signal formed by combining upstream link signals received from the subband dividers 39 and 41 for the subband #i. The signal processing unit 42 outputs, to the subband combining unit 43, the signal formed by combining the wired line upstream link signal with the wireless connection upstream link signal, in accordance with the instruction signal.

In the operation BC, the subband combining unit 43 causes the combined signal output from the signal processing unit 42 to be stored in the signal format (illustrated in FIG. 3) as a frequency domain signal of the upstream link signal of the subband #i.

In the operation BD, the controller 46 determines whether or not the quality Q1 is higher than the quality Q2. When the quality Q1 is higher than the quality Q2 (Yes in the operation BD), the process proceeds to the operation BE. When the quality Q1 is not higher than the quality Q2 (No in the operation BD), the process proceeds to the operation BF.

In the operation BE, the controller 46 outputs an instruction signal to the signal processing unit 42 to instruct the signal processing unit 42 to select, as a signal to be output, the upstream link signal received from the subband divider 41 for the subband #i. The signal processing unit 42 outputs, to the subband combining unit 43, the signal received from the subband divider 41 or the wired line upstream link signal in accordance with the instruction signal. After that, the process proceeds to the operation BC.

In the operation BF, the controller 46 outputs an instruction signal to the signal processing unit 42 to instruct the signal processing unit 42 to select, a signal to be output, the upstream link signal received from the subband divider 39 for the subband #i. The signal processing unit 42 outputs, to the subband combining unit 43, the signal received from the subband divider 39 or the wireless connection upstream link signal in accordance with the instruction signal. After that, the process proceeds to the operation BC.

Refer to FIG. 6. In the operation AI, the controller 46 increments the value of the variable i by 1. In the operation AJ, the controller 46 determines whether or not the value of the variable i is larger than the number p of the subbands. When the value of the variable i is larger than the number p of the subbands (Yes in the operation AJ), the process proceeds to the operation AK. When the value of the variable i is not larger than the number p of the subbands (No in the operation AJ), the process returns to the operation AG.

In the operation AK, the upstream link transmitter 44 transmits the upstream link signal stored in the signal format by the subband combining unit 43 to the upstream-side device through the digital signal line 7-2.

In the present embodiment, the antenna devices 6 that are connected in cascade to the base station device 5 may each have a reception quality calculation function of calculating the quality of a wireless upstream link signal received by the antenna device 6. For the calculation of the quality of the received signal, the intensity of the signal received in the unassigned subband and the intensity of the signal received in the desired subband are used. Thus, each of the reception quality calculation functions may be achieved with a simple configuration.

Since the antenna devices 6 each have the reception quality calculation function, the antenna devices 6 may each selectively use the wired line upstream link signal and the wireless connection upstream link signal based on the qualities of the received signals. For example, when either the quality of the received wired line upstream link signal or the quality of the received wireless connection upstream link signal is low, the signals are not combined, and a signal with a higher quality may be selected from among the signals and transmitted to the upstream-side device.

As a result, in the antenna system in which the plurality of antenna devices 6 are connected in cascade to the base station device 5, the quality of the upstream link signal may be improved. Thus, a throughput characteristic of the antenna system for the upstream link signal may be improved.

A method for determining an unassigned subband is described. The base station device 5 may specify, as the unassigned subband, a subband that is not assigned to any of the mobile station devices 4 may be specified as the unassigned subband based on scheduling performed by the scheduler 11.

In addition, the base station device 5 may specify a fixed subband as the unassigned subband or may change the subband specified as the unassigned subband. The base station device 5 may periodically change the unassigned subband. The base station device 5 may change the unassigned subband so that each of all the subbands #1 to #p is specified as the unassigned subband at least once during a given time period.

In order to calculate the quality of a signal received in a certain subband, the reception quality calculator 45 of the antenna device 6 may treat, as the intensity of the undesired signal, the intensity (power) r2 of a signal received in an unassigned subband that is consecutive to the certain subband.

When the unassigned subband is changed over time, the reception quality calculator 45 may store the intensity r2 of the signal received in each of the subbands when the subband is specified as the unassigned subband. In order to calculate the quality of a signal received in a certain subband, the reception quality calculator 45 may treat, as the intensity of the undesired signal, the intensity r2 (of the received signal) calculated and stored when the certain subband has been specified as the unassigned subband in the past. In this manner, the quality of the received signal may be measured with higher accuracy using the intensity r2 (of the received signal) calculated when a subband that is consecutive to or the same as the certain subband is specified as the unassigned subband.

When it is assumed that average inter-cell interference components in all frequency bands do not vary, the intensity r2 of a signal received in an unassigned subband that is not consecutive to the certain subband may be treated as the intensity of the undesired signal.

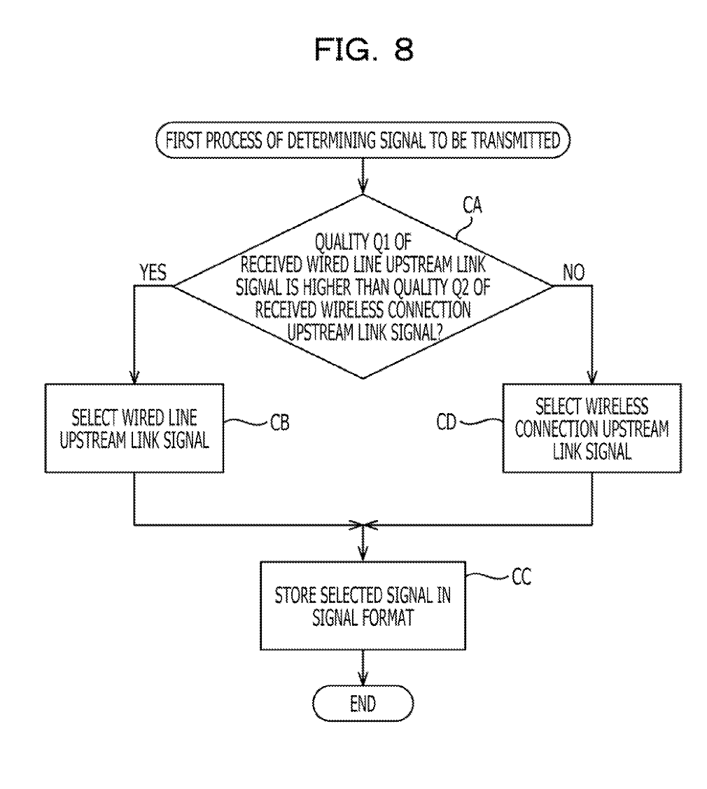

Next, another example of the method for determining an upstream link signal (to be transmitted to the upstream-side device through the digital signal line 7-2) by means of the controller 46 is described. FIG. 8 is a flowchart of a second example of the first process (to be performed in the operation AH illustrated in FIG. 6) of determining a signal to be transmitted. In another embodiment, the following operations CA to CC may be steps.

In the operation CA, the controller 46 determines whether or not the quality Q1 of the wired line upstream link signal received in the subband #i is higher than the quality Q2 of the wireless connection link signal received in the subband #i. When the quality Q1 is higher than the quality Q2 (Yes in the operation CA), the process proceeds to the operation CB. When the quality Q1 is not higher than the quality Q2 (No in the operation CA), the process proceeds to the operation CD.

In the operation CB, the controller 46 outputs an instruction signal to the signal processing unit 42 to instruct the signal processing unit 42 to select, as a signal to be output, the upstream link signal received from the subband divider 41 for the subband #i. The signal processing unit 42 outputs, to the subband combining unit 43, the signal received from the subband divider 41 or the wired line upstream link signal in accordance with the instruction signal. After that, the process proceeds to the operation CC.

In the operation CC, the subband combining unit 43 causes the signal output from the signal processing unit 42 to be stored in the signal format illustrated in FIG. 3 as a frequency domain signal of the upstream link signal of the subband #i.

In the operation CD, the controller 46 outputs an instruction signal to the signal processing unit 42 to instruct the signal processing unit 42 to select, as a signal to be output, the upstream link signal received from the subband divider 39 for the subband #i. The signal processing unit 42 outputs, to the subband combining unit 43, the signal received from the subband divider 39 or the wireless connection upstream link signal in accordance with the instruction signal. After that, the process proceeds to the operation CC.

In the present embodiment, the wired line upstream link signal is compared with the wireless connection upstream link signal; the wired line upstream link signal or the wireless connection upstream link signal, which has a higher quality than the other signal, is selected; and the selected signal with the higher quality is transmitted to the upstream-side device. In the present embodiment, the combining units 50 (illustrated in FIG. 5) of the signal processing unit 42 may be omitted, and the configurations of the antenna devices 6 are simple.

Next, another embodiment of the antenna devices and the base station device 5 are described. In the aforementioned embodiment, in each of the antenna devices 6, when the wireless connection upstream link signal and the wired line upstream link signal are not combined, the antenna device 6 selects one of the signals and transmits the selected signal to the upstream-side device. In the following description, the selected one of the signals is indicated by the “selected signal”; and the other of the signals, which is not selected, is indicated by the “unselected signal”.

In the embodiment described below, the antenna device 6 causes the unselected signal to be stored in a storage region that is provided to store an upstream link signal to be transmitted in the unassigned subband and is included in the signal format to be transmitted through the digital signal line 7-2, and the antenna device 6 then transmits the unselected signal to the upstream-side device. In the following description, the storage region that is provided to store an upstream link signal to be transmitted in the unassigned subband and is included in the signal format is indicated by the “unassigned region” in some cases.

The base station device 5 acquires, from the original storage region and the unassigned region, upstream link signals received in the same subband. After the base station device 5 corrects the phases of the upstream link signals, the base station device 5 performs maximum ratio combining on the upstream link signals by combining the upstream link signals.

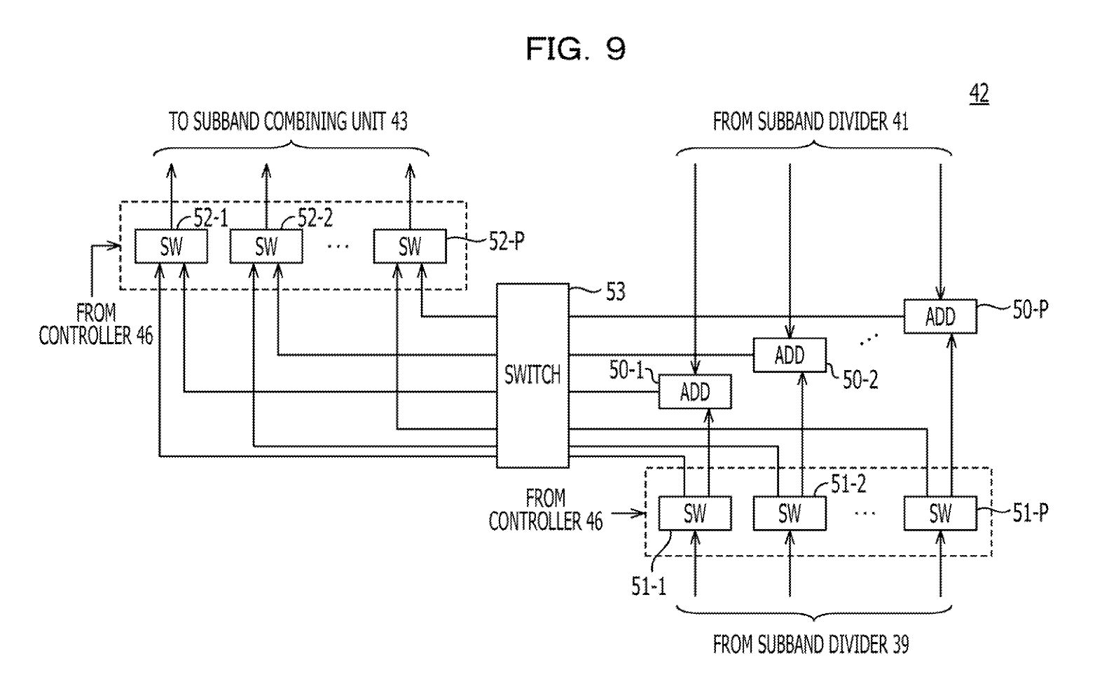

FIG. 9 is a diagram illustrating a second example of the signal processing unit 42 that is used in the present embodiment. The signal processing unit 42 has a switch 53. The switch 53 switches connection relationships between the second outputs of the switches 51-1 to 51-p and the first inputs of the switches 52-1 to 52-p in accordance with an instruction signal transmitted from the controller 46. In addition, the switch 53 switches connection relationships between the outputs of the combining units 50-1 to 50-p and the second inputs of the switches 52-1 to 52-p. The switch 53 is an example of a second selector.

It is assumed that the unselected signal in a subband #x among the subbands #1 to #p exists. The controller 46 instructs the switch 53 so that the output of a combining unit 50-x from which the unselected signal is output, or the second output of a switch 51-x from which the unselected signal is output, is connected to the input of a switch 52-y to which a signal (to be output to the subband combining unit 43) in an unassigned subband #y is input. As a result, the subband combining unit 43 causes the unselected signal in the subband #x to be stored in an unassigned region for the unassigned subband #y.

In addition, the controller 46 may cause a signal stored in the unassigned region of the signal format received from the downstream-side device to be stored again in the unassigned region for storing a signal to be transmitted to the upstream-side device, in a similar manner to the unselected signal. In this case, the controller 46 may instruct the switch 53 to connect the input of the switch 52-y to the output of the combining unit 50-y from which the wired line upstream link signal stored in the unassigned region is output, for example.

When a plurality of unselected signals exist, the controller 46 may sequentially select the unselected signals in order from a signal with the highest quality, and control the signal processing unit 42 so that the selected signals are stored in the unassigned region.

When the signal in the subband #x is stored in the unassigned region for the unassigned subband #y, the controller 46 may generate subband storage information that indicates that the signal in the subband #x is stored in the unassigned region for the unassigned subband #y. The controller 46 may cause the upstream link transmitter 44 to transmit the subband storage information to the upstream-side device through the digital signal line 7-2. The subband storage information may be multiplexed into the signal format by storing the subband storage information in a header portion Hy of the signal format, for example.

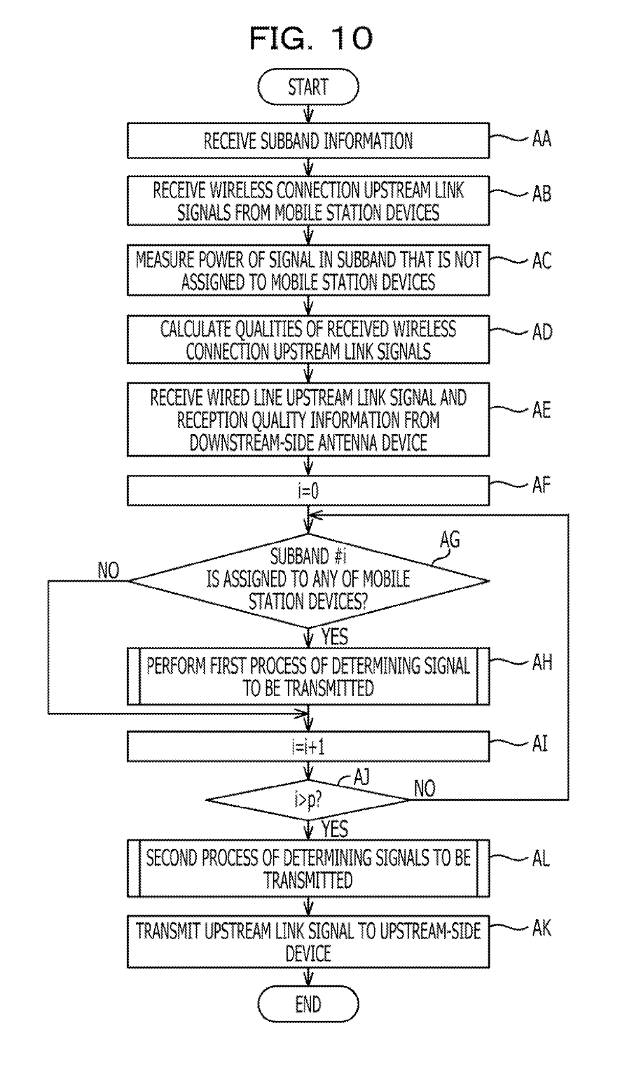

Next, a process that is performed by each of the antenna devices 6 according to the present embodiment is described. FIG. 10 is a flowchart of a second example of the process to be performed by the antenna device 6. In another embodiment, the following operations AA to AL may be steps. The operations AA to AK illustrated in FIG. 10 are the same as the operations AA to AK illustrated in FIG. 6.

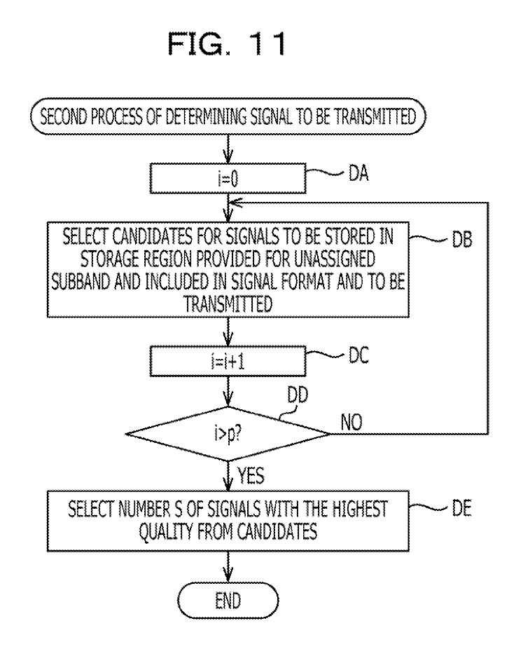

In the operation AL, the controller 46 performs a second process of determining signals to be stored in a number s of unassigned regions and transmitted. FIG. 11 is a flowchart of the second process of determining signals to be transmitted. In another embodiment, the following operations DA to DE may be steps.

In the following operations DA to DD, a process is repeatedly performed for the number p of the subbands. In the operation DA, the controller 46 substitutes 1 into the variable i.

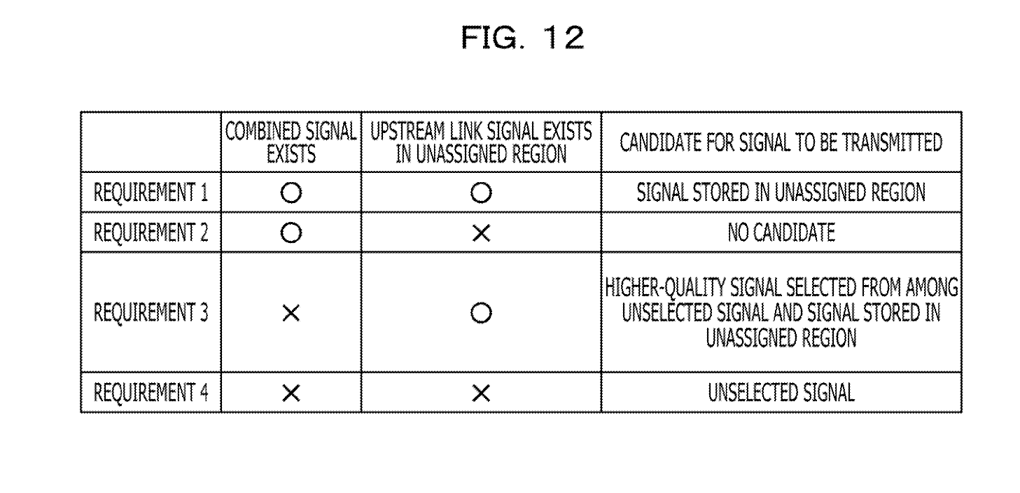

In the operation DB, the controller 46 selects candidates for signals to be stored in the storage region for the unassigned subband and transmitted from among upstream link signals in the subband #i. FIG. 12 is a diagram illustrating requirements for the selection of signals to be stored in the unassigned region and transmitted.

The controller 46 selects a signal to be stored in the unassigned region for each of the subbands #1 to #p based on whether or not each of requirements 1 to 4 described below is satisfied.

(Requirement 1)

Satisfying the requirement 1 indicates that the wired line upstream link signal is combined with the wireless connection upstream link signal and that a signal in the subband #i is already stored in an unassigned region for storing a signal received from the downstream-side device. In this case, the controller 46 selects the signal stored in the unassigned region as the candidate.

(Requirement 2)

Satisfying the requirement 2 indicates that the wired line upstream link signal is combined with the wireless connection upstream link signal and that the signal in the subband #i is not stored in the unassigned region for storing a signal received from the downstream-side device. In this case, the controller 46 determines that a candidate does not exist.

(Requirement 3)

Satisfying the requirement 3 indicates that the wired line upstream link signal is not combined with the wireless connection upstream link signal and that the signal in the subband #i is already stored in the unassigned region for storing a signal received from the downstream-side device. In this case, the controller 46 selects a signal with a higher quality as the candidate from among the unselected signal and the signal stored in the unassigned region.

(Requirement 4)

Satisfying the requirement 4 indicates that the wired line upstream link signal is not combined with the wireless connection upstream link signal and that the signal in the subband #i is not stored in the unassigned region for storing a signal received from the downstream-side device. In this case, the controller 46 selects the unselected signal as the candidate.

Refer to FIG. 11. In the operation DC, the controller 46 increments the variable i by 1. In the operation DD, the controller 46 determines whether or not the value of the variable i is larger than the number p of the subbands. When the value of the variable i is larger than the number p of the subbands (Yes in the operation DD), the process proceeds to the operation DE. When the value of the variable i is not larger than the number p of the subbands (No in the operation DD), the process returns to the operation DB.

In the operation DE, the controller 46 selects a number s of received upstream link signals with the highest quality from among the candidates selected for the subbands, and causes the selected signals to be stored in the storage region (of the signal format) for the unassigned subband.

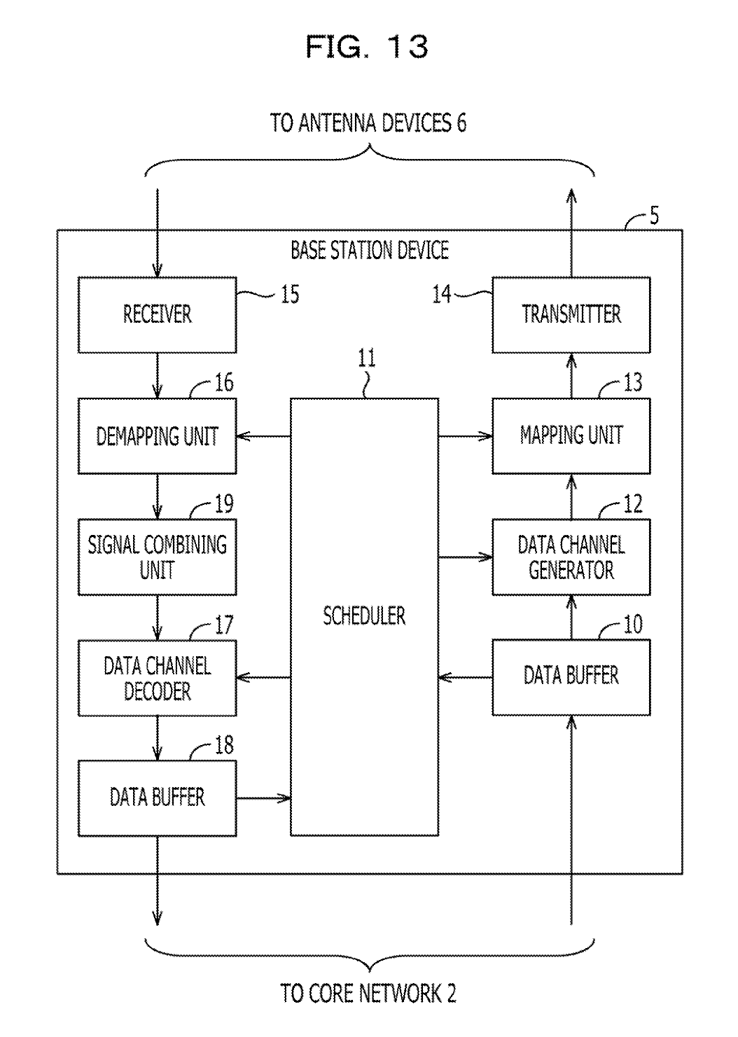

Next, the configuration of the base station device 5 according to the present embodiment and a process to be performed by the base station device 5 according to the present embodiment are described. FIG. 13 is a diagram illustrating a second example of the configuration of the base station device 5. The base station device 5 includes a signal combining unit 19. The signal combining unit 19 receives, from the demapping unit 16, the data separated for the users.

The signal combining unit 19 identifies a user corresponding to a signal stored in the storage region for the unassigned subband based on the subband storage information multiplexed into the signal format. The signal combining unit 19 corrects the phase of the signal stored in the storage region for the unassigned region and the phase of the signal stored in the original storage region for a subband assigned to the identified user. After that, the signal combining unit 19 combines the signals. The signal combining unit 19 outputs the combined signal to the data channel decoder 17.

In the present embodiment, the unselected signal is transmitted to the base station device using a storage region provided to store an upstream link signal in the unassigned subband, and is used for the maximum ratio combining of the upstream link signals. Thus, the quality of the received upstream link signal may be improved in the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments have been described in detail, it should be understood that the various changes, substitutions, and alterations could be made hereto without departing from the spirit and scope of the invention.

What is claimed is:

1. An antenna device that is connected to a base station device via a cascade connection, comprising:
a first receiver that receives, from the base station device, subband information that specifies a subband that is among a plurality of subbands obtained by dividing a frequency band and is not assigned to a mobile station device;
a second receiver that receives, from another antenna device connected on a downstream side of the cascade connection, an upstream link signal transmitted by the mobile station device and received by the other antenna device and reception quality information of the upstream link signal;
a wireless receiver that receives a wireless upstream link signal transmitted by the mobile station device; and
a comparator that compares a quality of the wireless upstream link signal with the reception quality information based on power of the wireless upstream link signal and power of a received signal in the subband specified in the subband information.

2. The antenna device according to claim 1, further comprising:
a first selector that selects either the wireless upstream link signal or the upstream link signal based on the result of the comparison made by the comparator; and
a transmitter that transmits the signal selected by the selector toward an upstream side of the cascade connection.

3. The antenna device according to claim 1, further comprising:
a determining unit that determines, based on the result of the comparison made by the comparator, whether or not the wireless upstream link signal is combined with the upstream link signal; and
a combining unit that combines the wireless upstream link signal with the upstream link signal into a signal so as to form a combined signal; and
a transmitter that transmits the combined signal formed by the combining unit toward an upstream side of the cascade connection.

4. The antenna device according to claim 3,
wherein the combining unit includes a first selector that selects either the wireless upstream link signal or the upstream link signal based on the result of the comparison made by the comparator when the combining unit does not combine the wireless upstream link signal and the upstream link signal, and
wherein the transmitter transmits the signal selected by the first selector.

5. The antenna device according to claim 4, further comprising:
a signal generator that generates a signal by storing upstream link signals to be transmitted in a plurality of subbands in a signal format having a plurality of storage regions for storing upstream link signals in the subbands, the generated signal being transmitted through the cascade connection; and
a second selector that selects an upstream link signal that is not selected by the first selector and is stored in a storage region that is among the plurality of storage regions and provided for the subband specified in the subband information.

6. A communication system comprising:
a base station device; and
a plurality of antenna devices that are connected to the base station device via a cascade connection,
wherein the base station device includes:
an assigning unit that divides a frequency band into a plurality of subbands and assigns subbands to mobile station devices; and
a subband information transmitter that transmits, to the plurality of antenna devices, subband information that specifies a subband that is among the plurality of subbands and is not assigned to any of the mobile station devices,
wherein the antenna devices each include:
a first receiver that receives the subband information from the base station device;
a second receiver that receives, from another antenna device connected on a downstream side of the cascade connection, an upstream link signal transmitted by a mobile station device and received by the other antenna device and reception quality information of the upstream link signal;
a wireless receiver that receives a wireless upstream link signal transmitted by the mobile station device; and
a comparator that compares the reception quality information received by the second receiver with a quality of the wireless upstream link signal based on power of the wireless upstream link signal and power of a received signal in the subband specified in the subband information.

7. The communication system according to claim 6,
wherein the antenna devices each further include:
a first selector that selects either the wireless upstream link signal or the upstream link signal based on the result of the comparison made by the comparator; and
a transmitter that transmits the signal selected by the first selector toward an upstream side of the cascade connection.

8. The communication system according to claim 6,
wherein the antenna devices each further include:
a determining unit that determines, based on the result of the comparison made by the comparator, whether or not the wireless upstream link signal is combined with the upstream link signal;
a combining unit that combines the wireless upstream link signal with the upstream link signal into a signal so as to form a combined signal; and
a transmitter that transmits the combined signal formed by the combining unit toward an upstream side of the cascade connection.

9. The communication system according to claim 8,
wherein the antenna devices each include a first selector that selects either the wireless upstream link signal or the upstream link signal based on the result of the comparison made by the comparator when the combining unit does not combine the wireless upstream link signal and the upstream link signal, and
wherein the transmitters transmit the upstream link signals selected by the first selectors.

10. The communication system according to claim 9,
wherein the antenna devices further include:
a signal generator that generates a signal by storing upstream link signals to be transmitted in a plurality of subbands in a signal format having a plurality of storage regions for storing upstream link signals in the subbands, the generated signal being transmitted through the cascade connection; and
a second selector that selects an upstream link signal that is not selected by the first selector and is stored in a storage region that is among the plurality of storage regions and provided for the subband specified in the subband information,
wherein the transmitter transmits the upstream link signals stored in the signal format and specific information that specifies a subband of the upstream link signal selected by the second selector, and
wherein the base station device includes:
a receiver that receives the upstream link signals transmitted by the transmitter and the specific information transmitted by the transmitter;
a corrector that corrects phases of upstream link signals, one of the upstream link signals being stored in a storage region that is among the plurality of storage regions and provided for the subband specified in the specific information, the other of the upstream link signals being stored in a storage region that is among the plurality of storage regions and provided for the subband that is not assigned by the assigning unit; and
a combining unit that combines the upstream link signals that have the corrected phases.

11. A base station device that is connected to a plurality of antenna devices via a cascade connection, comprising:
an assigning unit that divides a frequency band into a plurality of subbands and assigns subbands to mobile station devices;
a receiver that receives, from the antenna devices that receive upstream link signals transmitted in the subbands from the mobile station devices, the upstream link signals stored in a signal format and specific information through the cascade connection, the signal format having a plurality of storage regions for storing the upstream link signals in the subbands, the specific information specifying a subband in which an upstream link signal that is stored in a storage region that is among the plurality of storage regions and provided for a subband that is not assigned by the assigning unit is transmitted;
a corrector that corrects phases of upstream link signals, one of the upstream link signals being stored in a storage region that is among the plurality of storage regions and provided for the subband specified in the specific information, the other of the upstream link signals being stored in a storage region that is among the plurality of storage regions and provided for the subband that is not assigned by the assigning unit; and
a combining unit that combines the upstream link signals that have the corrected phases.

12. A communication method that is performed by a plurality of antenna devices that are connected to a base station device via a cascade connection, comprising:
first receiving, from the base station device, subband information that specifies a subband that is among a plurality of subbands obtained by dividing a frequency band and is not assigned to any of mobile station devices;
second receiving, from another antenna device that is among the plurality of antenna devices and connected on a downstream side of the cascade connection, an upstream link signal transmitted by a mobile station device and received by the other antenna device and reception quality information of the upstream link signal;
receiving a wireless upstream link signal transmitted by the mobile station device; and
comparing the quality of the wireless upstream link signal with the reception quality information received in the second receiving based on power of the wireless upstream link signal and power of a received signal in the subband specified in the subband information.

13. The communication method according to claim 12, further comprising:
selecting either the wireless upstream link signal received in the first receiving or the upstream link signal received in the second receiving based on the result of the comparison; and
transmitting the selected signal toward an upstream side of the cascade connection.

14. The communication method according to claim 12, further comprising:
determining, based on the result of the comparison, whether or not the wireless upstream link signal received in the first receiving is combined with the upstream link signal received in the second receiving;
combining the wireless upstream link signal received in the first receiving with the upstream link signal received in the second receiving into a signal so as to form a combined signal; and
transmitting the combined signal formed in the combining toward an upstream side of the cascade connection.

15. The communication method according to claim 14, further comprising:
selecting either the wireless upstream link signal received in the first receiving or the upstream link signal received in the second receiving based on the result of the comparison when the upstream link signals are not combined; and
transmitting the selected signal.

16. The communication method according to claim 15, further comprising:
generating a signal by storing upstream link signals to be transmitted in the plurality of subbands in a signal format having a plurality of storage regions for storing the upstream link signals in the subbands, the generated signal being transmitted through the cascade connection; and
selecting an upstream link signal that is not selected in the selecting and is stored in a storage region that is among the plurality of storage regions and provided for the subband specified in the subband information.

17. A communication method that is performed by a base station device that is connected to a plurality of antenna devices via a cascade connection, comprising:
dividing a frequency region into a plurality of subbands and assigning subbands to mobile station devices;
receiving, from the antenna devices that receive upstream link signals transmitted in the subbands from the mobile station devices, the upstream link signals stored in a signal format and specific information through the cascade connection, the signal format having a plurality of storage regions for storing the upstream link signals in the subbands, the specific information specifying a subband in which an upstream link signal that is stored in a storage region that is among the plurality of storage regions and is provided for a subband that is not assigned to the mobile station devices is transmitted;
correcting phases of upstream link signals, one of the upstream link signals being stored in a storage region that is among the plurality of storage regions and provided for the subband specified in the specific information, the other of the upstream link signals being stored in a storage region that is among the plurality of storage regions and provided for the subband that is not assigned in the assigning; and
combining the upstream link signals that have the corrected phases.
